(19) United States
(12) Patent Application Publication
(10) Pub. No.: US 2018/0161831 A1
(43) Pub. Date: Jun. 14, 2018

(54) AUTOMATIC DOOR AND DUST REMOVAL DEVICE THEREOF

(71) Applicant: MIRLE AUTOMATION CORPORATION, HSINCHU (TW)

(72) Inventor: JING-TANG WANG, HSINCHU (TW)

(21) Appl. No.: 15/839,302

(22) Filed: Dec. 12, 2017

Related U.S. Application Data
(60) Provisional application No. 62/433,839, filed on Dec. 14, 2016.

(30) Foreign Application Priority Data
Feb. 24, 2017 (TW) 106106446

(51) Int. Cl. B08B 5/04; B08B 13/00; E05D 13/00; E05F 15/70

(52) U.S. Cl. CPC B08B 5/04; B08B 13/00; E05D 13/00; E05F 15/70; B08B 2205/00; E05Y 2201/684; E05Y 2900/132; E05Y 2800/744; E05Y 2201/688

(57) ABSTRACT

A dust removal device installed on a slide rail of an automatic door is provided. The slide rail includes a slide groove on the bottom side thereof and is connected to a plurality of door panels. The slide rail includes a top plate, where a plurality of dust discharging holes is disposed. The dust removal device further includes a dust extracting case disposed on the top plate. The dust extracting includes an air passage at the inside, which communicates with the plurality of dust discharging holes. The dust removal device further includes a negative pressure device connected to the dust extracting case so as to generate a negative pressure at the inside of the dust extracting case and the air passage.

### BACKGROUND OF THE INVENTION

### 1. Field of the Invention

The present disclosure relates to an automatic door and a dust removal device thereof, and more particularly to an automatic door and a dust removal device thereof that are used in a clean room.

### 2. Description of Related Art

The manufacturing process of some products such as semiconductors, LCDs and solar panels needs to be performed in a highly clean environment; therefore, these kinds of products are often made in a clean room. Due to the trend of minimization in the industries, the semiconductors, LCDs and solar panels of the recent designs of recent design tend to have enlarged base board, narrowed wires, and thus a higher component density. As a result, the requirements for clean rooms are getting demanding.

An automatic door for clean rooms in the prior art has a slide rail and a plurality of movable door panels connected to the slide rail from beneath. The slide rail has at least one slide groove that includes driving members such as roller wheels and belts. The movable door panels are connected to the roller wheels and belts through connecting devices, and can move reciprocatingly along the slide groove driven by the driving members.

With the driving members driving the door panels frequently, the surrounding space of an automatic door of the prior art is often contaminated by dust particles generated by the movements of the driving members and the door panels, in which the dust particles drift out of the slide rail from the openings or open gaps thereof.

For the above reasons, dust particles generated from frictional interactions between the components of the automatic door inside the slide rail contribute to pollutants in the clean room. Most solutions to this problem in the prior art utilize roller wheels and driving belts made of abrasion resistant materials so as to reduce the amount of dust particles. However, owing to frequent movements of the components inside the slide rail, dust particles are not avoidable no matter what materials are chosen.

### SUMMARY OF THE INVENTION

The main object of the present disclosure is to provide an automatic door and a dust removal device thereof that effectively reduce dust particles generated by the automatic door.

In order to achieve the aforementioned objects, one embodiment of the present disclosure provides a dust removal device for an automatic door, in which the automatic door includes a slide rail and at least one door panel. The slide rail includes at least one slide groove and a top plate located above the slide groove. A top end portion of the at least one door panel is accommodated in the at least one slide groove and movable reciprocatingly along the longitudinal axis of the slide groove. The dust removal device includes a plurality of dust discharging holes, a dust extracting case and a negative pressure device. The plurality of dust discharging holes are disposed on the top plate and connected to the at least one slide groove, in which the position of the plurality of dust discharging holes corresponds to that of the at least one slide groove. The dust extracting case covers the plurality of dust discharging holes. The dust extracting case includes an air passage at the inside thereof, in which the air passage communicates with the plurality of dust discharging holes. The negative pressure device is connected to the dust extracting case so as to generate a negative pressure in the air passage of the dust extracting case.

According to one embodiment of the present disclosure, the at least one slide groove includes an opening on the bottom side, and the plurality of dust discharging holes and the dust extracting case are arranged in parallel to the longitudinal axis of the slide groove. The plurality of dust discharging holes are covered by the dust extracting case, in which when the air passage is at a negative pressure, an air flow flowing from the opening to the at least one slide groove and entering the air passage through the plurality of dust discharging holes is generated so as to carry the dust particles inside the at least one slide groove to the air passage.

According to one embodiment of the present disclosure, the negative pressure device includes: a plurality of gas extracting devices disposed on a lateral side of the dust extracting case, in which one end of each of the plurality of gas extracting devices is connected to the dust extracting case.

According to one embodiment of the present disclosure, each of the plurality of gas extracting devices includes a filtering device at an end opposite the dust extracting case, each of the filtering devices including a plurality of filter screens, in which each of the filtering devices draws gas out of the air passage and makes the gas pass through the filtering device.

According to one embodiment of the present disclosure, the negative pressure device is a gas extracting pipe connected to a negative-pressure extracting device.

In order to achieve the aforementioned objects, another embodiment of the present disclosure provides an automatic door. The automatic door includes a slide rail, at least one door panel, a dust extracting case, and a negative pressure device. The slide rail has at least one slide groove and a top plate located above the slide groove. The position of the plurality of dust discharging holes corresponds to that of the at least one slide groove. A top end portion of the at least one door panel is accommodated in the at least one slide groove and connected thereto through a plurality of connecting devices. The at least one door panel is reciprocatingly movable along the longitudinal axis of the slide groove. The dust extracting case is disposed on the top plate and covers a plurality of the dust extracting holes. The dust extracting case includes an air passage at the inside thereof, in which the air passage communicates with the plurality of dust discharging holes. The negative pressure device is connected to the dust extracting case so as to generate a negative pressure in the air passage of the dust extracting case.

For a better understanding of the present disclosure, the following embodiments are provided along with illustrations to facilitate the disclosure of the present disclosure.

### BRIEF DESCRIPTION OF THE EXTRACTINGS

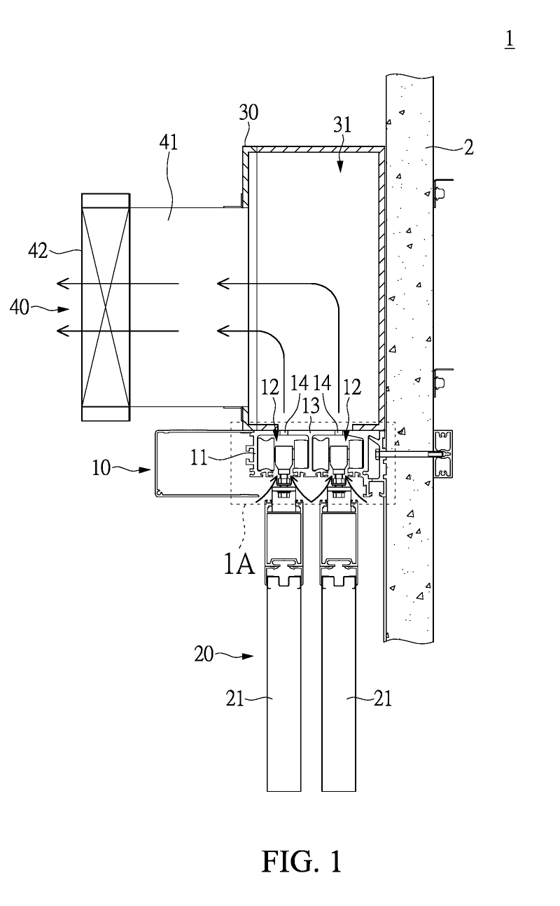

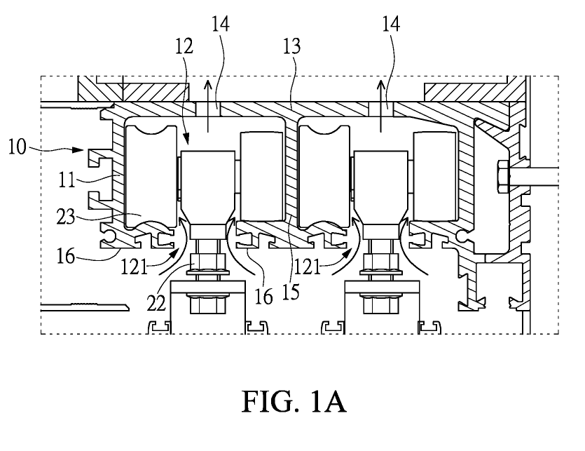

FIG. 1 is a sectional view illustrating an automatic door according to a first embodiment of the present disclosure.

FIG. 1A is a partially enlarged view illustrating the automatic door according to the first embodiment of the present disclosure.

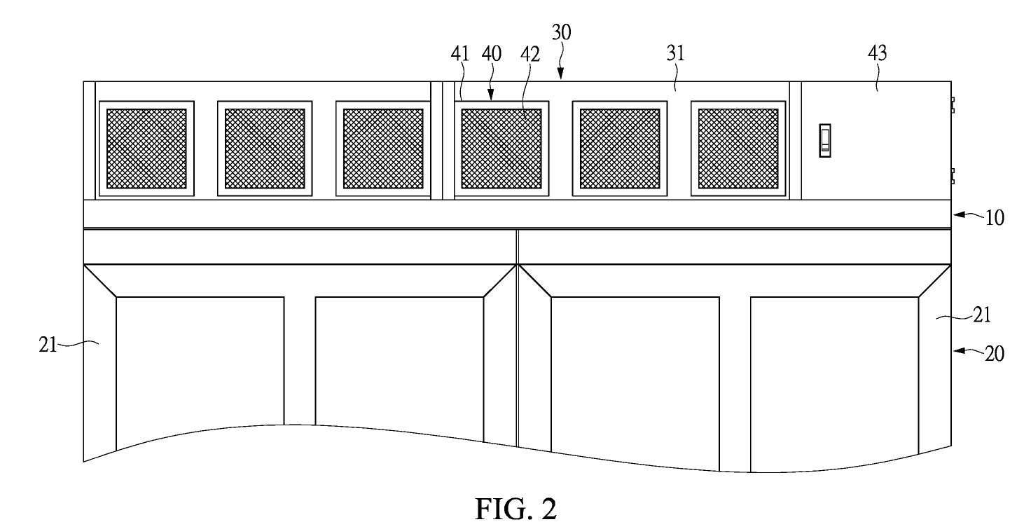

FIG. 2 is a front view illustrating the automatic door according to the first embodiment of the present disclosure.

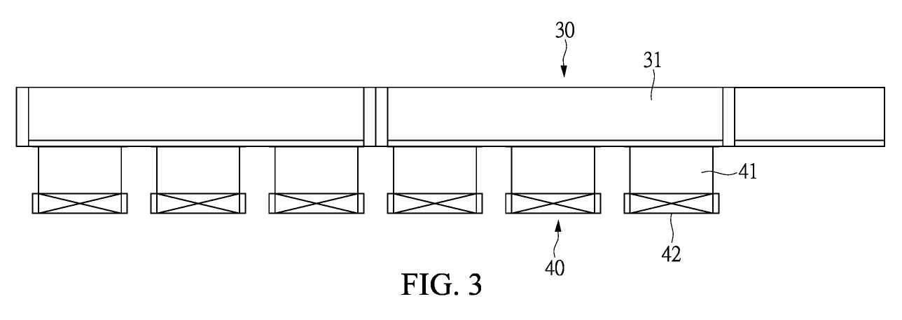

FIG. 3 is a top view illustrating the automatic door according to the first embodiment of the present disclosure.

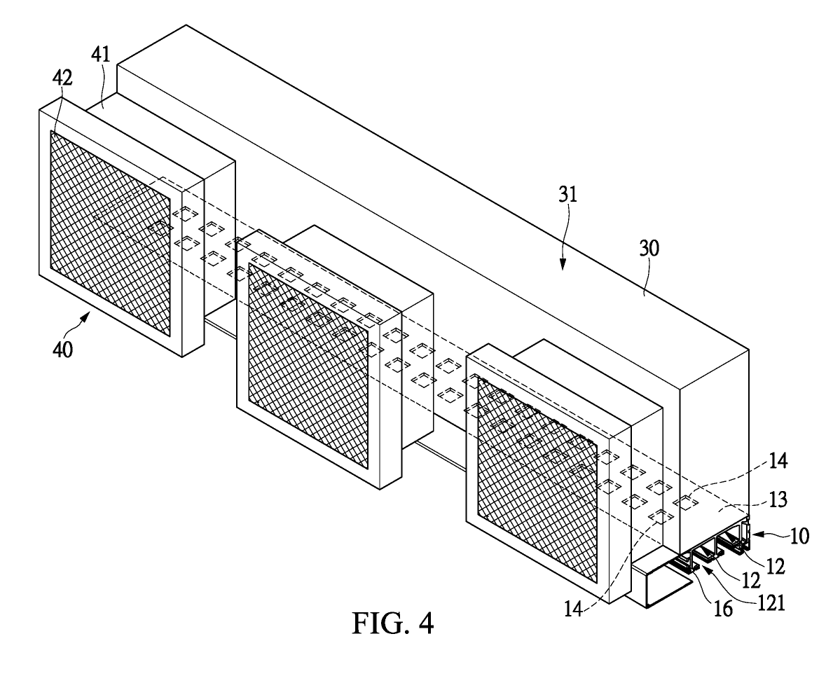

FIG. 4 is a perspective schematic view illustrating the dust removal device according to the first embodiment of the present disclosure.

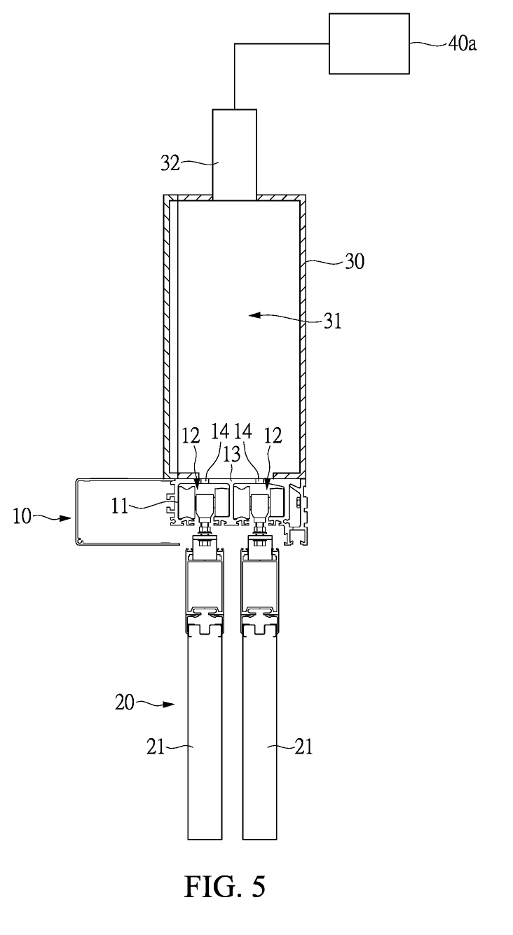

FIG. 5 is a sectional view illustrating an automatic door according to a second embodiment of the present disclosure.

### DETAILED DESCRIPTION OF THE PREFERRED EMBODIMENTS

The aforementioned illustrations and following detailed description are for exemplary purpose and are not limitations to the scope of the present disclosure. Other objectives and advantages related to the present disclosure will be illustrated in the following description and appended drawings.

The present disclosure provides an automatic door and a dust removal device thereof. With reference to FIGS. 1 to 4, an automatic door 1 according to the first embodiment of the present disclosure includes a slide rail 10, a movable door 20, a dust extracting case 30, and a plurality of negative pressure devices 40.

The slide rail 10 is an aluminum extrusion body 11, as shown in FIGS. 1 and 1A. In the present embodiment, the slide rail 10 can be installed on a wall 2, and the movable door 20 can be installed on the entrance of the wall 2 through the slide rail 10. A top plate 13 is disposed on the top surface of the slide rail 10. Two slide grooves 12 are formed side by side on the bottom side of the top plate 13, and a divider 15 is disposed between so as to separate the two slide grooves 12. Each of the two slide grooves 12 has an opening 121 on the bottom side. The bottom portion of the slide rail 10 includes a bottom plate 16 on either side of the opening 121 of each of the slide grooves 12.

The movable door 20 includes a plurality of door panels 21, each of which has a plurality of connecting devices 22 at the top end thereof and is connected to the slide grooves 12 situated at the bottom side of the slide rail 10 through the connecting devices 22. In the present disclosure, the connecting devices 22 at the top end of the door panels 21 are connected to a plurality of roller wheels 23 respectively, in which the plurality of roller wheels 23 engage the bottom plate 16 of the slide rail 10 in a manner such that the door panels 21 move reciprocatingly along the longitudinal axis of the slide grooves 12 with the guidance thereof. The slide grooves 12 further include belts (not shown in the drawings) acting as driving devices that drive the door panels 21 so that the movable door 20 switches between on and off states.

In the present embodiment, a plurality of dust discharging holes 14 are disposed on the top plate 13 of the slide rail 10, in which the position of the plurality of dust discharging holes 14 corresponds to that of the slide grooves 12. With reference to FIG. 4, the dust discharging holes 14 are arranged parallel to the longitudinal axis of the slide grooves 12 so that each of the dust discharging holes 14 communicates with the slide grooves 12.

The dust extracting case 30 is disposed on top of the slide rail 10. In this embodiment, the dust extracting case 30 is a box with a rectangular section, in which the bottom of the dust extracting case 30 is connected to the top of the top plate 13, covering the plurality of dust discharging holes 14. The dust extracting case 30 includes an air passage 31 at the inside thereof, with the plurality of the dust discharging holes 14 communicating with the air passage 31. The negative pressure devices 40 are connected to the dust extracting case 30 so that the air inside the dust extracting case 30 is drawn out of the dust extracting case 30, generating a negative pressure inside the dust extracting case 30.

With reference to FIGS. 1 and 1A, since the plurality of dust discharging holes 14 on top of the top plate 13 are covered by the dust extracting case 30 and each of the slide grooves 12 communicates with the air passage 31, the air inside the slide grooves 12 can be drawn into the air passage 31 when the dust extracting case 30 is at a negative pressure, generating an air flow flowing from the slide groove 12 of the slide grooves into the slide grooves 12 and entering the air passage 31 via the dust discharging holes 14. In this way, by generating a negative pressure environment inside the air passage 31, air is forced to flow unidirectionally from the slide groove 12 to the air passage 31, drawing dust particles inside the slide groove 12 to the dust extracting case 30 and out of the dust extracting case 30 via the negative pressure device 40.

With reference to FIGS. 2, 3, and 4, in the first embodiment, each of the negative pressure devices 40 is installed on the lateral side of the dust extracting case 30. Furthermore, each negative pressure device 40 includes an air extractor 41 and a filter device 42. The gas extracting device 41 includes an exhaust fan located at the inside thereof. One end of the gas extracting device 41 is connected to the dust extracting case 30, with the other end thereof being connected to the filtering device 42. With the gas extracting device 41, air inside the air passage 31 can be extracted from the air passage 31 and forced to pass through the filtering device 42.

In this embodiment, the filtering device 42 includes a plurality of filter screens. The filter screens are HEPA (High-Efficiency Particulate Air) filters, through which dust particles can be blocked and prevented from drifting into the air again and polluting the space surrounding the automatic door 1. The filtering device 42 can be detached easily for replacement or cleansing so as to maintain high dust-removal efficiency.

In this embodiment, the dust extracting case 30 and the negative pressure devices 40 are disposed on the slide rail 10 in parallel to the longitudinal axis of the slide grooves 12, with the negative pressure devices 40 being equidistantly spaced apart. Moreover, a control case 43 is disposed on a lateral side of the dust extracting case 30, in which the control case 43 is connected to the plurality of negative pressure devices 40 so as to control the operation of the negative pressure devices 40.

It should be noted that the position of each of the plurality of negative pressure devices 40 is arranged according to an air flow simulation so that every portion of the air passage 31 is at the same negative pressure level when the negative pressure devices 40 are in operation. In this way, air in each slide groove 12 can flow steadily into the dust extracting case 30 at a contact flow rate and pressure, and the dust particles in each slide groove 12 can be drawn into the dust extracting case 30.

Through the afore-mentioned technical solutions, dust particles generated by the components inside the slide rail 10 of the automatic door 1 can all be drawn into the dust extracting case 30 and extracted therefrom by the negative pressure devices 40. Therefore, the automatic door 1 of the present disclosure can prevent the dust particles generated by the components inside the slide rail 10 from polluting the space surrounding the automatic door 1, conforming to the requirements for clean rooms nowadays.

Referring to FIG. 5, in the second embodiment of the present disclosure, the automatic door 1 has a structure similar to that of the first embodiment. Therefore, the same components will not be further described herein. In this embodiment, the negative pressure devices are not directly connected to the dust extracting case 30 but instead through an extension pipe line. Specifically, in this embodiment, the negative pressure device includes an gas extracting pipe 32 connected between the dust extracting case 30 and a negative pressure extracting device 40a at both ends. The negative-pressure extracting device 40a can be a vacuum pump or an air extractor. The negative pressure extracting device 40a generates a vacuum drawing force that extracts air from the dust extracting case 30 through the gas extracting pipe 32 so as to remove dust particles therefrom.

The second embodiment of the present disclosure can also effectively remove the dust particles generated by the components inside the automatic door 1 of the automatic door 1, thereby enhancing the cleanliness and level of dust resistance of the automatic door 1.

The description illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A dust removal device for an automatic door, wherein the automatic door includes a slide rail and at least one door panel, the slide rail including at least one slide groove and a top plate located above the slide groove, a top end portion of the at least one door panel being accommodated in the at least one slide groove and movable reciprocatingly along the longitudinal axis of the slide groove, the dust removal device comprising:
a plurality of dust discharging holes disposed on the top plate and connected to the at least one slide groove, in which the position of the plurality of dust discharging holes corresponds to that of the at least one slide groove;
a dust extracting case covering the plurality of dust discharging holes, the dust extracting case including an air passage at the inside thereof, in which the air passage communicates with the plurality of dust discharging holes; and
a negative pressure device connected to the dust extracting case so as to generate a negative pressure in the air passage of the dust extracting case.

2. The dust removal device according to claim 1, wherein the at least one slide groove includes an opening on the bottom side, the plurality of dust discharging holes and the dust extracting case being arranged in parallel to the longitudinal axis of the slide groove, in which the plurality of dust discharging holes are covered by the dust extracting case, wherein when the air passage is at a negative pressure, an air flow flowing from the opening to the at least one slide groove and entering the air passage through the plurality of dust discharging holes is generated so as to carry the dust particles inside the at least one slide groove to the air passage.

3. The dust removal device according to claim 2, wherein the negative pressure device includes: a plurality of gas extracting devices disposed on a lateral side of the dust extracting case, wherein one end of each of the plurality of gas extracting devices is connected to the dust extracting case.

4. The dust removal device according to claim 3, wherein each of the plurality of gas extracting devices includes a filtering device at an end opposite the dust extracting case, each of the filtering device including a plurality of filter screens, in which each of the gas extracting device extracts gas from the air passage and forces the gas to pass through the filtering device.

5. The dust removal according to claim 2, wherein the negative pressure device is a gas extracting pipe connected to a negative-pressure extracting device.

6. An automatic door, comprising:
a slide rail including at least one slide groove and a top plate located above the slide groove, in which the position of the plurality of dust discharging holes corresponds to that of the at least one slide groove;
at least one door panel, a top end portion of the at least one door panel being accommodated in the at least one slide groove and connected thereto through a plurality of connecting devices, the at least one door panel being reciprocatingly movable along the longitudinal axis of the slide groove; and
a dust extracting case disposed on the top plate and covering a plurality of the dust extracting holes, the dust extracting case including an air passage at the inside thereof, in which the air passage communicates with the plurality of dust discharging holes; and
a negative pressure device connected to the dust extracting case so as to generate a negative pressure in the air passage of the dust extracting case.

7. The automatic door according to claim 6, wherein the slide rail is an aluminum extrusion, the at least one slide groove being formed on the bottom side of the slide rail and including an opening on the bottom side, and wherein when the air passage is at a negative pressure, an air flow flowing from the opening to the at least one slide groove and then entering the air passage through the plurality of dust discharging holes is generated so as to carry the dust particles inside the at least one slide groove to the air passage.

8. The automatic door according to claim 7, wherein the negative pressure device includes: a plurality of gas extracting devices disposed on a lateral side of the dust extracting case, wherein one end of each of the plurality of gas extracting devices is connected to the dust extracting case.

9. The automatic door according to claim 8, wherein each of the plurality of gas extracting devices includes a filtering device at an end opposite the dust extracting case, each of the filtering devices including a plurality of filter screens, in which each of the filtering devices draws gas out of the air passage and makes the gas pass through the filtering device.

10. The automatic door according to claim 7, wherein the negative pressure device is a gas extracting pipe connected to a negative-pressure extracting device.
